(19) United States
(12) Patent Application Publication
(10) Pub. No.: US 2023/0020267 A1
(43) Pub. Date: Jan. 19, 2023

(54) DRIVE ASSISTANCE APPARATUS, DRIVE ASSISTANCE METHOD, AND DRIVE ASSISTANCE PROGRAM

(71) Applicant: DENSO CORPORATION, Kariya-city (JP)

(72) Inventors: Shunsuke MOCHIZUKI, Kariya-city (JP); Kazuhito TAKENAKA, Kariya-city (JP); Midori KATO, Kariya-city (JP); Kenji MUTOU, Kariya-city (JP)

(21) Appl. No.: 17/934,507

(22) Filed: Sep. 22, 2022

Related U.S. Application Data
(63) Continuation of application No. PCT/JP2020/049250, filed on Dec. 28, 2020.

(30) Foreign Application Priority Data
Mar. 26, 2020 (JP) 2020-056784

(51) Int. Cl. G01C 21/34

(52) U.S. Cl. CPC G01C 21/3407; G01C 21/3453

(57) ABSTRACT

A drive assistance apparatus predicts demand for vehicles in each area including a driving route, based on a demand prediction model for predicting the demand in the area. The drive assistance apparatus also predicts the frequency of occurrence of an obstacle in each of the regions obtained by dividing the area, based on a frequency model for predicting the frequency of occurrence of the obstacle in the region, and generates a driving route of the vehicle, based on the predicted demand in the area and the predicted frequency of occurrence of the obstacle.

### CROSS-REFERENCE TO RELATED APPLICATION

This application is the U.S. bypass application of International Application No. PCT/JP2020/049250 filed on Dec. 28, 2020, which designated the U.S. and claims priority to Japanese Patent Application No. 2020-056784 filed on Mar. 26, 2020, the entire disclosure of which are incorporated herein by reference.

### BACKGROUND

### Technical Field

The present disclosure relates to a drive assistance apparatus, a drive assistance method, and a drive assistance program.

### Description of the Related Art

Along with the advancement of autonomous driving, there is contemplated a technique for dispatching or deadheading a vehicle to an appropriate place on demand.

For example, there is a technique for appropriately dispatching taxicabs based on forecast information on predicted users' demand.

### SUMMARY

A drive assistance apparatus according to an aspect of the present disclosure includes: a demand prediction unit that predicts demand for a vehicle in each area including a driving route, based on a demand prediction model for predicting the demand in the area; a frequency prediction unit that predicts frequency of occurrence of an obstacle in each of regions obtained by dividing the area, based on a frequency model for predicting the frequency of occurrence of an obstacle in the region; and a driving route generation unit that generates a driving route of the vehicle, based on the predicted demand in the area and the predicted frequency of occurrence of obstacles.

### BRIEF DESCRIPTION OF THE DRAWINGS

FIG. 1 is a diagram illustrating a demand prediction model, a frequency model, and a list of considerations for monitoring cost.

FIG. 2 is a diagram illustrating an example of a high-accuracy map.

FIG. 3 is a conceptual diagram related to demand prediction in individual areas provided by a demand prediction model.

FIG. 4 is a diagram illustrating an example of a case with the occurrence of an impassible region due to an obstacle.

FIG. 5 is a conceptual diagram of temporal transition in a driving section with the occurrence of an impassable region.

FIG. 6 is a block diagram illustrating a configuration of a drive assistance system according to an embodiment of the present disclosure.

FIG. 7 is a block diagram illustrating a hardware configuration of a drive assistance apparatus.

FIG. 8 is a diagram illustrating an example of a dispatch control process routine.

FIG. 9 is a diagram illustrating an example of a deadheading control process routine.

FIG. 10 is a diagram illustrating an example of a monitoring control process routine.

### DETAILED DESCRIPTION OF THE PREFERRED EMBODIMENTS

Along with the advancement of autonomous driving, there is contemplated a technique for dispatching or deadheading a vehicle to an appropriate place on demand.

For example, there is a technique for appropriately dispatching taxicabs based on forecast information on predicted users' demand (Japanese Patent Application No. 2019-91274).

However, the inventor's detailed study has revealed that the technique described in Japanese Patent Application No. 2019-91274 was addressed to vehicles driven by human drivers, without consideration given to a problem that autonomous driving vehicles might become incapable of driving due to an obstacle on the road. Thus, if an obstacle is present on the road, the service in the corresponding area may be interrupted. The inventor has also discovered how long the service interruption would continue depended on the type of the obstacle. The inventor has further found out an issue that information on impassable routes was not considered in the technique of the related art.

As a solution to this problems, dynamic obstacle monitoring based on information obtained from a sensor-equipped vehicle is suggested. However, the inventor has also found an issue that the monitoring of an obstacle requires the movement of a vehicle. Thus, in the case of moving a vehicle for monitoring, it is important how much the operational cost for the service can be made efficient.

Hereinafter, an embodiment of the present disclosure will be described with reference to the drawings.

First, the present embodiment will be outlined.

The present embodiment is based on the assumption that drive assistance is provided to autonomous driving vehicles. In the conventional drive assistance for autonomous driving, a dispatch plan for deadheaded vehicles is developed to maximize sales, from a demand prediction model and an operation status. The conventional demand prediction is made on the basis of operation track records and various types of external data (for example, weather, operational information, and events). However, no consideration is given to impassable routes in the conventional drive assistance.

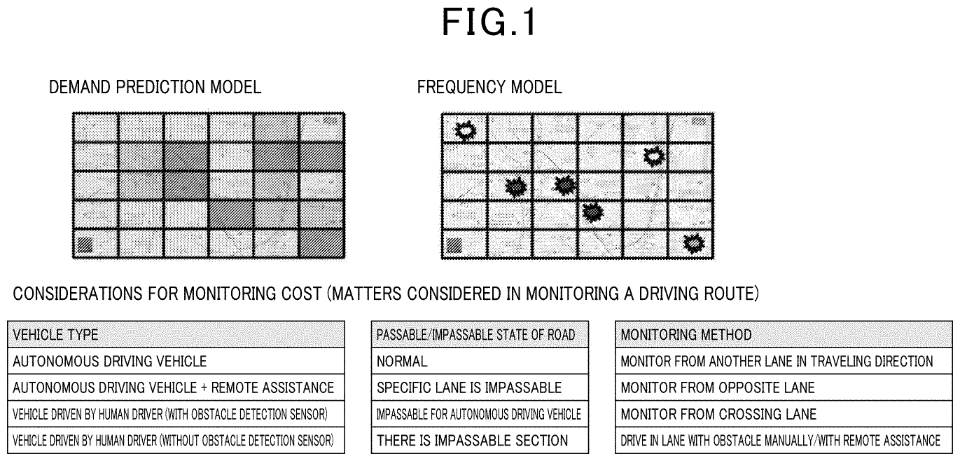

In a drive assistance system of the present embodiment, the frequency of occurrence of an obstacle is predicted on the basis of a frequency model in which passable/impassable states of roads, the type of an obstacle, and the cost for an obstacle affecting the sales are modeled. Then, a vehicle driving route is generated on the basis of the prediction of profits in individual areas provided by the demand prediction model, the loss of revenue-generating opportunities due to the frequency of occurrence of an obstacle predicted in the frequency model, monitoring cost, and the like. FIG. 1 is a diagram illustrating a demand prediction model, a frequency model, and a list of considerations for monitoring cost. In the demand prediction model, the degrees of demand in each area in each time period are determined. In the frequency model, the probability of occurrence of an obstacle in each region of the area in each time period is determined. Each area on the map is divided into regions based on road data. Each region constitutes a grid-based arbitrary region divided by various elements, such as one section, driving lane, or the like of the road, for example. The list of considerations for monitoring cost includes the type of vehicle, the passable/impassable state of roads, and the monitoring method. Examples of the type of vehicle include “autonomous driving vehicle”, “autonomous driving vehicle with remote assistance”, “vehicle driven by a human driver (with an obstacle detection sensor), and “vehicle driven by a human driver (without an obstacle detection sensor)”. Example of the passable/impassible state of roads include “normal”, “impassable in a specific lane”, “impassable for autonomous driving vehicles”, and “impassable section”. Example of considerations for the monitoring method include “monitoring from another lane in the traveling direction”, “monitoring from the opposing lane”, “monitoring from a lane in the crossing direction”, and “driving in the lane with an obstacle manually/via remote assistance”.

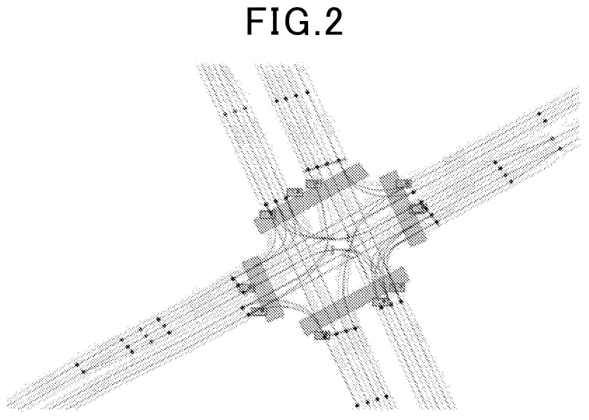

Next, a prerequisite technique related to operation of autonomous driving vehicles will be described. Existing road data is used to operate the autonomous driving vehicles. In the operation of autonomous driving vehicles, the autonomous driving vehicles drive on the basis of map information called a high-accuracy map in which roads are managed at the lane level. FIG. 2 is a diagram illustrating an example of a high-accuracy map. In the operation of autonomous driving vehicles, first, passable regions are determined on the basis of the high-accuracy map as illustrated in FIG. 2. Autonomous driving vehicles 110 are actually driven in conformity with traffic rules on roads and through real-time detection of other driving vehicles, pedestrians, obstacles, traffic signs, traffic signals, and the like on the actual roads by sensors in the autonomous driving vehicles 110. That is, each autonomous driving vehicle is driven with consideration given to: (1) setting a route to the destination (long-term prediction); (2) determining a driving region based on actually existing surrounding vehicles and obstacles, and on traffic regulation information; and (3) monitoring the surrounding environment.

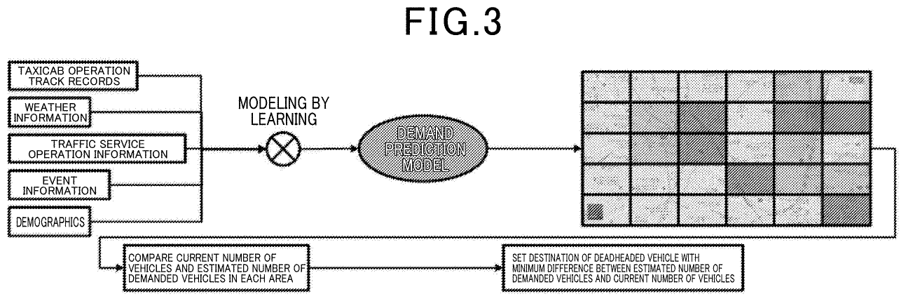

The demand prediction model is subjected to learning and updating with the use of driving data and external data. FIG. 3 is a conceptual diagram related to demand prediction in individual areas provided by the demand prediction model. As illustrated in FIG. 3, the demand prediction model is subjected to learning with various types of data such as driving data and external data. The driving data includes operation track records of taxicabs or the like operated as autonomous driving vehicles. The data on differences in demand among the days of a week and latest demand increases is extracted from the operation track records and used to obtain periodic and short-term demand trends. The external data includes weather information, traffic service operation information, event information, demographics, and the like. The weather information is weather forecasting data on temperature and rainfall amount. From the weather forecasting data, it is possible to predict the influence of warm and cold temperatures and rainfall on changes in demand. The operation information of the traffic service includes quick announcement data on the service situation such as train delay and service suspension. The operation information of the traffic service can reflect changes in taxicab demand under various influences such as suspension of train service. The event information includes schedule data of events such as concerts and sports events. From the event information, an increase in taxicab demand by event attendees can be predicted. The demographics include prediction data on demographic dynamics taking into account population movements due to relocations and temporary residence. The demographic data is used to obtain changes in taxicab demand due to actual movements of population that could not be obtained from the other external data.

Next, the frequency model will be described. If an autonomous driving vehicle is dispatched to a region in response to a reservation for a ride-hailing service, the service may not be provided to the region at the last minute due to the avoidance of an obstacle existing around the dispatch destination. In this case, a non-autonomous driving vehicle may be dispatched instead. However, this may result in a significantly long waiting time so that the user may cancel the service. In order to handle this problem, the frequency model for predicting the occurrence of an obstacle in the dispatch destination is generated to predict the presence or absence of an obstacle in the corresponding section. The frequency model is subjected to learning with obstacle occurrence information and external data. Based on the prediction of occurrence of an obstacle, it is determined which to be dispatched, an autonomous driving vehicle and a general vehicle driven by a human driver, thereby minimizing the loss of service delivery opportunities.

Next, a method for detecting the obstacle occurrence information will be described. The high-accuracy map includes only static information on road structures and does not include information to be considered in actual operation such as impassable sections due to construction or traffic accident and passable/impassable states of driving lanes due to an obstacle such as a parked vehicle on a lane. As a suggestion for solving this problem, management of on-road obstacle occurrence information by using sensors included in connected cars can be utilized as described in Reference Document 1. Reference Document 1 describes that individual vehicles driving in the same area perform object detection and feature extraction, for example, and the information obtained from the vehicles is registered in a database, and the database is used to acquire data on objects in proximity, determine similarity, and register obstacles and impassable regions.
(Reference Document 1) JP 2019-185756A

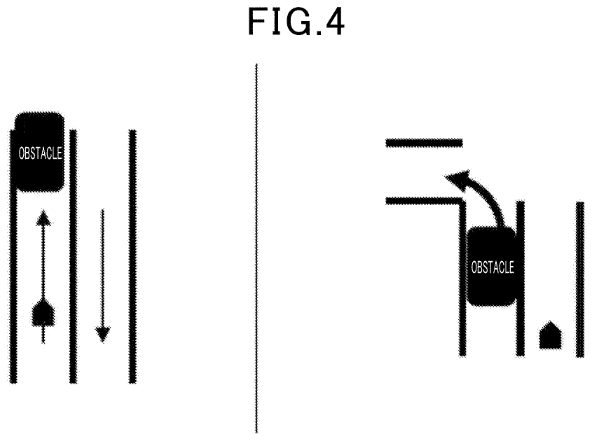

The correspondence between an obstacle and an impassable lane will be described. For example, the passable regions for an autonomous driving vehicle are determined according to the specification of the autonomous driving system. Accordingly, there may occur a region that is impassable due to an obstacle on the road. FIG. 4 is a diagram illustrating an example of the occurrence of an impassible region due to an obstacle. The left side of FIG. 4 illustrates a case in which there is an obstacle ahead in a lane change-prohibited lane and the own vehicle needs to stop in order to avoid the risk of collision with an oncoming vehicle. The right side of FIG. 4 illustrates a case in which there is a vehicle parked as an obstacle in front of an intersection. In this case, if a lane change is prohibited in a no-entry region, the own vehicle needs to go straight without turn left to take a detour. In such a case with an obstacle, the management center manages obstacle information and detects in advance the impassable region in the route to the destination. In this manner, selecting the impassible region at the route and lane levels enables the setting of a route avoiding an obstacle in advance.

For example, in the case of a general vehicle driven by a human driver, if there is an obstacle around the vehicle, the driver temporarily stops on the road and then rides or exits the vehicle. On the other hand, an autonomous driving vehicle cannot stop if there is a possibility of violation of traffic rules as described below, and thus may not provide the service in the corresponding section. For example, if there is no sufficient space on the road, the autonomous driving vehicle cannot stop. In the cases illustrated in FIG. 4, as a result of consideration of the demanded deadheading destination and driving risk, the autonomous driving vehicle may safely avoid the obstacle by making a lane change in advance, in preference to straying onto the opposing lane to steer around the obstacle. In that case, the autonomous driving vehicle makes a lane change to safely avoid the obstacle. Thereafter, if there is a lane change-disabled section, the autonomous driving vehicle becomes incapable of providing the service in the corresponding section. Accordingly, no service can be provided to passengers in the subsequent sections, and the sales expected on the basis of the original demand prediction may not be achieved.

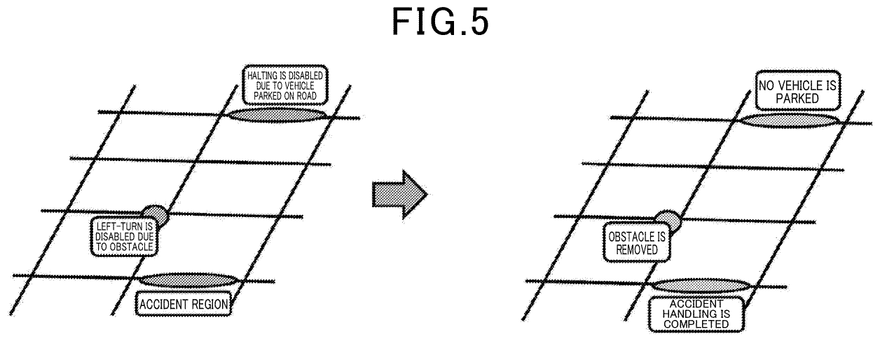

FIG. 5 is a conceptual diagram illustrating temporal transition in a driving section with the occurrence of an impassable region. As illustrated in FIG. 5, in the event of occurrence of an obstacle, an impassible region is set on the road for safe driving with avoidance of the obstacle. In this case, the impassable region is managed by the management center such that no autonomous driving vehicle will travel in the region, and thus the service is not provided in that area during the management. In order to make the impassible region a normal region again, it is necessary to update the obstacle information with the driving information from a connected car. However, since an autonomous driving vehicle mostly used as a connected car cannot drive in the impassible region, if the obstacle is removed from the corresponding region, it may take a long time to make the corresponding region the normal region. In order to solve this problem, a method for checking the status of the corresponding region is determined by generating a monitoring route based on a demand prediction model to decrease the loss of service delivery opportunities. Specific method for monitoring an obstacle will be described later.

The outline of the technique in the present embodiment has been described above. A configuration and operation of the present embodiment will be described below.

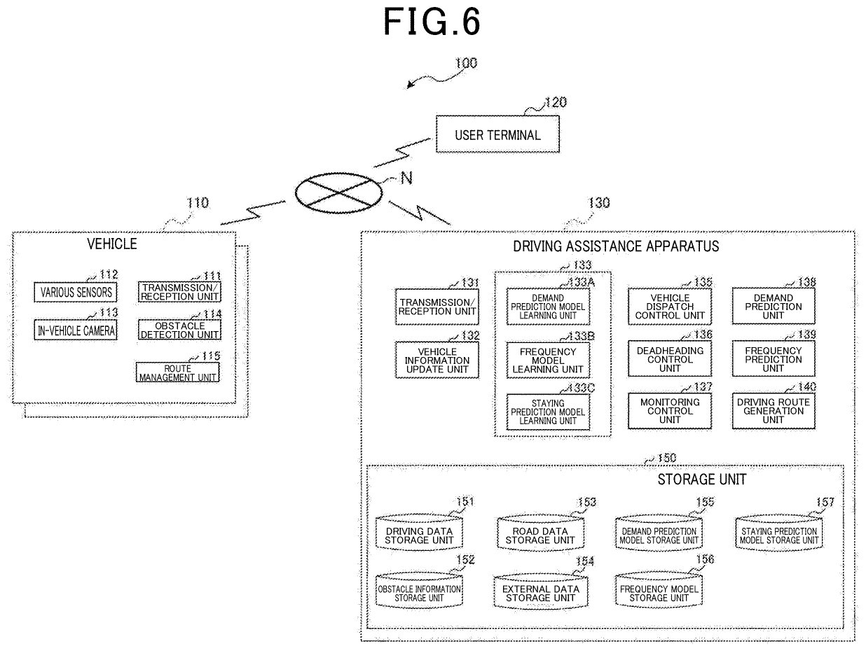

FIG. 6 is a block diagram illustrating a configuration of a drive assistance system 100 according to an embodiment of the present disclosure. As illustrated in FIG. 6, the drive assistance system 100 includes a vehicle 110, a user terminal 120, and a drive assistance apparatus 130, which are connected together via a network N.

The vehicle 110 is an autonomous driving vehicle that is a target of management by the drive assistance system 100. The vehicle 110 includes a transmission/reception unit 111, various sensors 112, an in-vehicle camera 113, an obstacle detection unit 114, and a route management unit 115.

The user terminal 120 includes display and input/output interfaces (not illustrated). The user terminal 120 accepts a vehicle dispatch request input by a user and transmits the vehicle dispatch request to the drive assistance apparatus 130. The vehicle dispatch request includes various kinds of information necessary for vehicle dispatch such as the desired dispatch time, current location, and destination location. The user terminal 120 also receives user vehicle dispatch information from the drive assistance apparatus 130 and presents the user vehicle dispatch information to the user on the display interface. The user vehicle dispatch information is information indicating the scheduled vehicle dispatch time, vehicle dispatch location, and the like.

The drive assistance apparatus 130 includes a transmission/reception unit 131, a vehicle information update unit 132, a learning unit 133, a vehicle dispatch control unit 135, a deadheading control unit 136, and a monitoring control unit 137. The drive assistance apparatus 130 also includes a demand prediction unit 138, a frequency prediction unit 139, a driving route generation unit 140, and a storage unit 150. The storage unit 150 includes a driving data storage unit 151, an obstacle information storage unit 152, a road data storage unit 153, an external data storage unit 154, a demand prediction model storage unit 155, a frequency model storage unit 156, and a staying prediction model storage unit 157.

Components of the vehicle 110 will be described. The transmission/reception unit 111 transmits and receives various kinds of data to and from the drive assistance apparatus 130. In the present embodiment, the transmission/reception unit 111 receives vehicle dispatch information, deadheading information, or monitoring information. The vehicle dispatch information is information that includes a driving route to a destination specified by the user in the vehicle dispatch request, and is associated with the user. The deadheading information is information that includes a driving route to a deadheading destination specified by the drive assistance apparatus 130. The monitoring information is information that includes a driving route for monitoring a monitoring target obstacle and the position of the monitoring target obstacle. The transmission/reception unit 111 also transmits the driving data including position information, obstacle information, and subtraction data on the monitoring target obstacle from the monitoring information, to the drive assistance apparatus 130.

The various sensors 112 are in-vehicle sensors such as a millimeter wave sensor, a raindrop sensor, and a collision sensor. The various sensors 112 also include measurement sensors that acquire position information, time information, driving route, and driving status such as driving behavior. The driving behavior includes whether or not the vehicle is in the autonomous driving state, vehicle speed, acceleration, steering, accelerating, and braking. The driving situation is transmitted to the drive assistance apparatus 130 on a regular basis.

The in-vehicle camera 113 is a camera that captures video images during the driving of the vehicle. The camera images (or camera video images) captured by the in-vehicle camera 113 are transmitted to the drive assistance apparatus 130 at the time of transmission of the obstacle information. The camera images may be transmitted on a regular basis.

The obstacle detection unit 114 monitors the states of the various sensors 112 and the images captured by the in-vehicle camera 113, and detects an obstacle existing on the driving path. The obstacle detection unit 114 uses an object detection method to detect the presence or absence of an obstacle. The obstacle detection unit 114 transmits the detected obstacle information to the drive assistance apparatus 130. The obstacle detection unit 114 may estimate the presence or absence of an obstacle through image analysis. The obstacle detection unit 114 also detects the subtraction data on the monitoring target object from the monitoring information, and includes the subtraction data in the obstacle information and transmits them to the drive assistance apparatus 130.

The route management unit 115 sets a driving route to the destination based on the received vehicle dispatch information, deadheading information, or monitoring information. Upon receipt of the vehicle dispatch information, deadheading information, or monitoring information from the drive assistance apparatus 130, the vehicle 110 sets the driving route.

The components of the drive assistance apparatus 130 will be described. The transmission/reception unit 131 receives the driving data and the obstacle information from the vehicle 110. The transmission/reception unit 131 receives the vehicle dispatch request from the user terminal 120. The transmission/reception unit 131 transmits the user vehicle dispatch information to the user terminal 120. The transmission/reception unit 131 transmits the vehicle dispatch information, deadheading information, or monitoring information to the vehicle 110. The drive assistance apparatus 130 may acquire the obstacle information not only from the vehicle 110 but also from external sensors in the corresponding area.

The vehicle information update unit 132 stores the driving data received from the vehicle 110 in the driving data storage unit 151. The vehicle information update unit 132 estimates an obstacle existing in the driving section in the corresponding area based on the obstacle information received from the vehicle 110, and stores the estimation as obstacle occurrence information indicating the obstacle and the impassible region due to the obstacle, in the obstacle information storage unit 152. The vehicle information update unit 132 also receives the subtraction data on the monitoring target obstacle from the vehicle 110 and updates the obstacle occurrence information with the received information. The obstacle occurrence information here includes information on the type and staying time of the obstacle. It is possible to determine whether the obstacle is a temporary obstacle or stationary obstacle from the type of the obstacle. For example, the temporary obstacle is a stopped vehicle, and the stationary obstacle is an obstacle that is difficult to remove such as a fallen tree. Since the obstacle occurrence information is updated also with the obstacle information obtained from the vehicle 110 to which a monitoring route is assigned under monitoring control, the presence or absence of an obstacle is updated depending on the predicted staying time. The obstacle occurrence information is an example of information on the region that is impassable due to the presence of an obstacle in the past.

The components of the storage unit 150 will be described. The driving data storage unit 151 stores the driving data received from the vehicle 110. The driving data stored here includes the current location of the vehicle 110, the unit price of the vehicle, the driving state, and operation track records if the vehicle is a taxicab. The driving state here indicates the dispatch/non-dispatch state, the circulation state (deadheading or monitoring), and the standby state. The driving state may be duplicated in one vehicle. For example, when the vehicle in the circulation state for deadheading enters the area where the circulation is ended, the standby state is additionally applied to overlap the circulation state. Hereinafter, on the assumption that the driving data is read from the driving data storage unit 151, the description of the driving data storage unit 151 will be omitted. The same thing applies to the other storage units.

The obstacle information storage unit 152 stores the obstacle occurrence information determined by the vehicle information update unit 132. The road data storage unit 153 stores road data in road structure information indicating the structures of the roads in individual areas. The external data storage unit 154 stores external data such as the weather information, traffic service operation information, event information, and demographics described above. The obstacle information storage unit 152 receives and updates the external data as appropriate.

The demand prediction model storage unit 155 stores the demand prediction model that has been subjected to learning or updating at a demand prediction model learning unit 133A. The demand prediction model is a model for predicting the demand for vehicles in individual areas in each time period as described above.

The frequency model storage unit 156 stores the frequency model that has been subjected to learning or updating at a frequency model learning unit 133B. The frequency model is a model for predicting the frequency of occurrence of an obstacle in each region included in the individual areas in each time period as described above.

The staying prediction model storage unit 157 stores a staying prediction model that has been subjected to learning or updating at a staying prediction model learning unit 133C. The staying prediction model is a model for predicting the staying time of an obstacle recorded in the obstacle occurrence information.

The learning unit 133 includes the demand prediction model learning unit 133A, the frequency model learning unit 133B, and the staying prediction model learning unit 133C. The demand prediction model learning unit 133A trains and updates the demand prediction model as appropriate in accordance with the necessity determined by the drive assistance apparatus 130. The demand prediction model learns with the past driving data and the external data stored in the corresponding parts of the storage unit 150 as learning data, by a deep learning method using a neural network. The demand prediction model learns so as to output prediction results of demand in individual areas in each time period.

The frequency model learning unit 133B trains and updates the frequency model as appropriate in accordance with the necessity determined by the drive assistance apparatus 130. The frequency model learns with the past obstacle occurrence information, external data, and road data stored in the corresponding parts of the storage unit 150 as learning data, by a deep learning method using a neural network or the like. The frequency model learns so as to output prediction results of the occurrence of frequency of an obstacle in each region of individual areas in each time period. The learning data here includes attribute information such as the road structures, traffic signals, and road signs in the road data.

The staying prediction learning unit 133C trains and updates the staying prediction model as appropriate at each update of the obstacle occurrence information. The staying prediction model learns with the obstacle occurrence information, external data, and road data stored in the corresponding parts of the storage unit 150 as learning data, by a deep learning method using a neural network or the like. The staying prediction model learns so as to output the prediction results of the staying time during which the obstacle recorded in the obstacle occurrence information will stay in the corresponding region.

In response to the vehicle dispatch request from the user terminal 120, the vehicle dispatch control unit 135 performs frequency prediction, determines a passable driving route in accordance with the frequency prediction, and arranges vehicle dispatch in accordance with the driving route. The vehicle dispatch control unit 135 causes the frequency prediction unit 139 to execute the frequency prediction, and causes the driving route generation unit 140 to generate the driving route. The arrangement of vehicle dispatch includes transmitting a dispatch assignment and vehicle dispatch information to the vehicle 110, and transmitting the user vehicle dispatch information to the user terminal 120, for example.

The deadheading control unit 136 performs demand prediction and frequency prediction in accordance with the necessity determined by the drive assistance apparatus 130, determines a demanded and passable driving route in accordance with the demand prediction and the frequency prediction, and performs deadheading control in accordance with the driving route. The deadheading control unit 136 causes the demand prediction unit 138 to execute the demand prediction. The deadheading control unit 136 executes the frequency prediction and the driving route generation similarly to the vehicle dispatch control unit 135. The deadheading control includes transmitting the assigned deadheading destination and the deadheading information to the vehicle 110, for example.

For a target obstacle existing on the driving route, the monitoring control unit 137 predicts the staying time of the target obstacle by using the staying prediction model, and generates a monitoring route in accordance with the prediction results. The target obstacle existing on the driving route here refers to an obstacle newly added to the obstacle occurrence information at the time of update. The monitoring control unit 137 transmits the monitoring information including the monitoring route to the vehicle 110. The monitoring information here may include information for detecting subtraction data. The monitoring control unit 137 may refer to the type of the obstacle to determine whether the obstacle is a temporary obstacle or a stationary obstacle. In this case, the monitoring control unit 137 may generate a monitoring route for only the temporary obstacle. The monitoring control unit 137 may not generate a monitoring route for the stationary obstacle or may lengthen the time interval at which to generate a monitoring route for the stationary obstacle as compared to the temporary obstacle.

The demand prediction unit 138 predicts demand in individual areas in each time period based on the demand prediction model, in response to the request from the deadheading control unit 136. The prediction results of demand determined here refer to the degree of demand for ride. The demand prediction unit 138 may determine the prediction results of demand in advance as a routine process, and return the prediction results of demand in response to the request from the deadheading control unit 136. For example, the demand prediction unit 138 may determine the prediction results of demand every day or every few hours.

The frequency prediction unit 139 predicts the frequency of occurrence of an obstacle in every region of areas in each time period, based on the frequency model, in response to the request from the vehicle dispatch control unit 135 or the deadheading control unit 136. The frequency prediction unit 139 may determine the prediction results of frequency of occurrence of an obstacle in advance as a routine process, and return the prediction results of demand in response to the request from the deadheading control unit 136. For example, the demand prediction unit 138 may determine the prediction results of demand every day or every few hours.

The driving route generation unit 140 generates the driving route of the vehicle in response to the request from the vehicle dispatch control unit 135 or the deadheading control unit 136. The process is different between vehicle dispatch and deadheading.

In the case of vehicle dispatch, the driving route generation unit 140 generates the driving route of the vehicle dispatch, based on the prediction results of frequency of occurrence of an obstacle provided by the frequency model, for individual vehicles as candidates for dispatch among the vehicles 110. In this example, the driving route generation unit 140 extracts candidates for roads to the dispatch destination specified in the dispatch request, based on the road data, for individual vehicles as candidates for dispatch. The candidates for roads are candidates for regions in roads that may be used for the driving route. The driving route generation unit 140 also calculates an obstacle prediction coefficient that indicates the possibility/impossibility risk of driving due to an obstacle, in accordance with the frequency of occurrence of an obstacle obtained using the frequency model. The driving route generation unit 140 also calculates an obstacle influence coefficient for the currently existing obstacle recorded in the obstacle occurrence information. The obstacle prediction coefficient can be determined, for example, such that there exists an obstacle in a region with an occurrence frequency equal to or higher than a specific value, and the cost of driving in such a region becomes high. The obstacle influence coefficient can be determined, for example, by acquiring the obstacle occurrence information and determining whether an obstacle exists in the region and, if any, what type of obstacle is present. The driving route generation unit 140 generates the driving route based on the road candidates, the obstacle prediction coefficient, and the obstacle influence coefficient, for each of the vehicles as the candidates for dispatch. The driving route generation unit 140 calculates the vehicle dispatch cost based on the movement cost (movement time) for the driving route and the unit price assigned to each of the vehicles as the candidates for dispatch. The driving route generation unit 140 then determines the vehicle to be dispatched in accordance with the vehicle dispatch costs of the individual vehicles as the candidates for dispatch. Accordingly, the driving route for the dispatch of the vehicle to be dispatched is determined, and the vehicle and the driving route of the vehicle are set as vehicle dispatch information. The obstacle prediction coefficient is an example of a first coefficient, and the obstacle influence coefficient is an example of a second coefficient.

In the case of deadheading, the driving route generation unit 140 generates the driving route to the deadheading destination, based on the prediction results of demand provided by the demand prediction model and the prediction results of frequency of occurrence of an obstacle provided by the frequency model, for each of vehicles to be deadheaded among the vehicles 110. First, the driving route generation unit 140 sets regions k (k∈K: K is an aggregate of regions as candidates for deadheading destination) as candidates for deadheading destination, based on demand in individual regions of areas indicated by the prediction results of demand. Then, for each of the set regions k as candidates for deadheading destinations, the driving route generation unit 140 extracts each of candidates for roads to the region k from the road data. The driving route generation unit 140 also calculates the obstacle prediction coefficients and the obstacle influence coefficients of the road candidates. For each of the regions k as the candidates for deadheading destination, the driving route generation unit 140 generates the driving route based on the road candidates, the obstacle prediction coefficient, and the obstacle influence coefficient. The driving route generation unit 140 then calculates a deadheading sales prospect in the region k, based on the obstacle prediction coefficient, the movement cost (movement time) for the driving route, and a sales prospect per vehicle in the region k. The deadheading sales prospect in the region k can be determined by calculating the sales prospect per vehicle in the region k×the obstacle prediction coefficient×the obstacle influence coefficient—the movement cost, for example. The driving route generation unit 140 then sets the region k with the highest deadheading sales prospect among the regions k, as a region k′ that is the deadheading destination, and determines the set deadheading destination as the deadheading destination of the vehicle to be deadheaded. Accordingly, the driving route to the region as the deadheading destination is generated for each of the vehicles to be deadheaded. The driving route generation unit 140 also sets the driving route as deadheading information. The deadheading sales prospect is an example of achievement prospect.

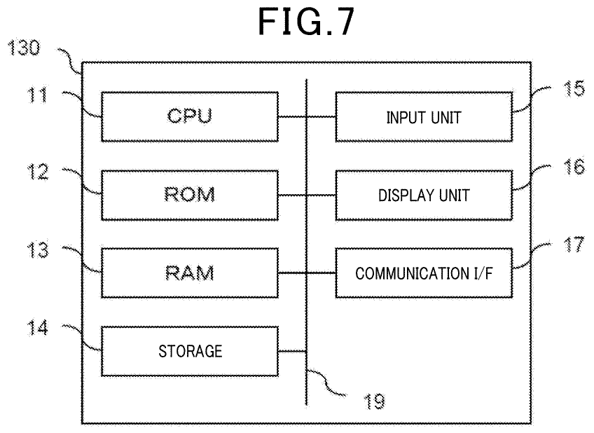

FIG. 7 is a block diagram illustrating a hardware configuration of the drive assistance apparatus 130. As illustrated in FIG. 7, the drive assistance apparatus 130 includes a central processing unit (CPU) 11, a read only memory (ROM) 12, a random access memory (RAM) 13, a storage 14, an input unit 15, a display unit 16, and a communication interface (I/F) 17. These components are communicably connected to each other via a bus 19.

The CPU 11 is a central processing unit, which executes various programs including a drive assistance program, and controls the components. That is, the CPU 11 reads a program from the ROM 12 or the storage 14, and executes the program with the RAM 13 as a work area. The CPU 11 controls the foregoing components and performs various arithmetic operations, in accordance with the programs stored in the ROM 12 or the storage 14. In the present embodiment, an assistance management process program is stored in the ROM 12 or the storage 14.

The ROM 12 stores the various programs and various kinds of data. The RAM 13 temporarily stores the programs or data, as a work memory. The storage 14 is formed of a storage device such as a hard disk drive (HDD) or a solid state drive (SSD), and stores various programs including an operating system and various kinds of data.

The input unit 15 includes a pointing device such as a mouse and a keyboard, which are used to perform various inputs.

The display unit 16 is a crystal liquid display, for example, which displays various kinds of information. The display unit 16 may be of a touch panel type that functions as the input unit 15.

The communication interface 17 is an interface for communication with other devices such as terminals, and is in conformity with standards such as Ethernet (registered trademark), FDDI, or Wi-Fi (registered trademark), for example.

An example of hardware configuration of the drive assistance apparatus 130 has been described above.

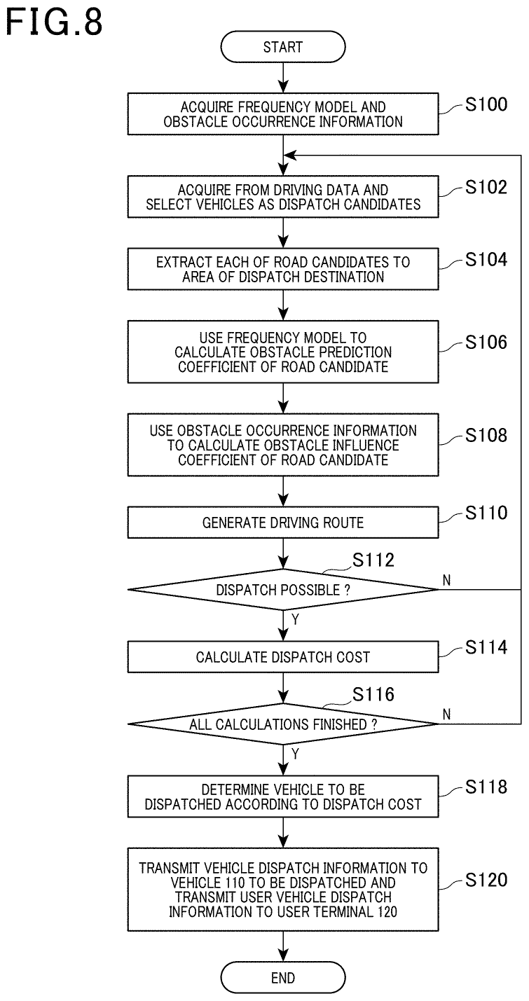

FIGS. 8 to 10 are flowcharts of a process routine performed by the drive assistance apparatus 130 in the drive assistance system 100 according to the embodiments of the present disclosure. The drive assistance process by the drive assistance apparatus 130 is mainly divided into a vehicle dispatch process, a deadheading control process, and a monitoring control process. The learning unit 133 performs various leaning processes in advance on various models. The obstacle occurrence information used in the process described below is updated as needed each time the obstacle information is received from the vehicle 110. The subtraction data on an obstacle resulting from the monitoring control process is also updated as needed by the obstacle information.

First, the vehicle dispatch control process will be described. FIG. 8 is a diagram illustrating an example of a dispatch control process routine. The vehicle dispatch control process is performed by the CPU 11 functioning as the vehicle dispatch control unit 135 or the demand prediction unit 138 upon receipt of a request from the vehicle dispatch control unit 135, the frequency prediction unit 139, or the driving route generation unit 140 to execute the following steps.

In step S100, the CPU 11 acquires the frequency model and the obstacle occurrence information.

In step S102, the CPU 11 acquires, from the driving data, information on the vehicles 110 around the area of the dispatch destination indicated in the vehicle dispatch request, and selects the vehicles as candidates for dispatch.

In step S104, the CPU 11 extracts the candidates for roads to the area of the dispatch destination based on the road data, for each of the vehicles as the candidates for dispatch. The road candidates are determined as individual regions of the area.

In step S106, the CPU 11 uses the frequency model to calculate the obstacle prediction coefficients of the road candidates for the vehicles as the dispatch candidates. The obstacle prediction coefficient can be determined as the frequency of occurrence of an obstacle in each of the regions, with each of the regions of the road candidates as input into the frequency model.

In step S108, the CPU 11 uses the obstacle occurrence information to calculate the obstacle influence coefficients for the road candidates for the vehicles as the dispatch candidates. The obstacle influence coefficient can be determined for each of the regions of the road candidates, by the presence or absence of an obstacle in the region recorded in the obstacle occurrence information. For example, the obstacle influence coefficient may be changed in accordance with the type and staying time of the obstacle. For example, if the type of the obstacle is recorded as a bus, the obstacle influence coefficient may be calculated as a low value because it is highly likely that the bus will move off soon. In contrast, if the type of the obstacle is a fallen tree or the like, the obstacle influence coefficient may be calculated as a high value because it is less likely that the obstacle will be moved off soon. If the staying time of the obstacle is long, the obstacle influence coefficient may be calculated as a low value because it is highly likely that the obstacle will move off soon. In reverse, if the staying time of the obstacle is short, the obstacle influence coefficient may be calculated as a high value because it is less likely that the obstacle will move off soon.

In step S110, the CPU 11 generates a driving route for the vehicle as dispatch candidate using an existing algorithm so as to minimize the cost related to the movement, based the road candidates, the obstacle prediction coefficient, and the obstacle influence coefficient. The CPU 11 also calculates the movement cost (movement time) related to the driving route. If there is a region with a high possibility of occurrence of an obstacle determined from the obstacle prediction coefficient, or if there is a region with the presence of an obstacle determined from the obstacle influence coefficient, it is considered that a driving route with a long movement time will be generated because it is necessary to detour around these regions.

In step S112, the CPU 11 determines whether it is possible to dispatch a vehicle on the driving route generated in step S110. If it is possible to dispatch a vehicle, the process moves to step S114. If it is not possible to dispatch a vehicle, the process returns to step S102 and the CPU 11 selects the next vehicle as a dispatch candidate. The determination can be made in accordance with an impassable region on the driving route.

In step S114, the CPU 11 calculates the vehicle dispatch cost for the vehicle as the dispatch candidate, based on the movement cost (movement time) related to the driving route and the unit price assigned to the vehicle as the dispatch candidate.

In step S116, the CPU 11 determines whether the calculation of the vehicle dispatch cost has completed on all the vehicles as dispatch candidates. If it is determined that the calculation has completed, the process moves to step S118. If it is determined that the calculation has not yet completed, the process returns to step S102 and the CPU 11 selects the next vehicle as dispatch candidate and repeats the process.

In step S118, the CPU 11 determines the vehicle to be dispatched from among the vehicles as the dispatch candidates in accordance with the dispatch costs of the vehicles as the dispatch candidates. This step may be performed before step S116 to select the optimum vehicle to be dispatched in sequence in response to the dispatch request.

In step S120, the CPU 11 transmits the vehicle dispatch information to the vehicle 110 to be dispatched and transmits the user vehicle dispatch information to the user terminal 120.

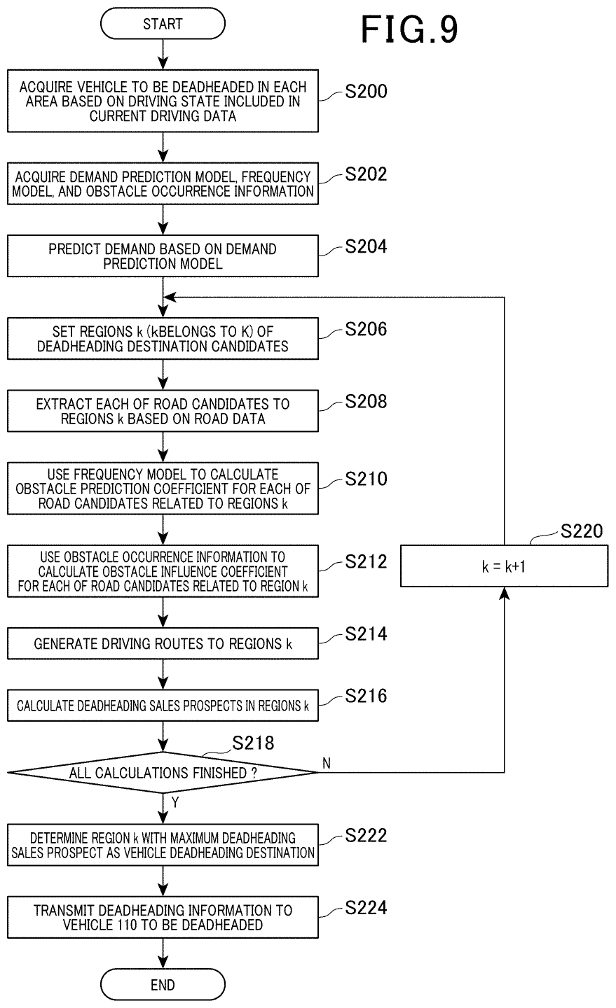

Next, the deadheading control process will be described. FIG. 9 is a diagram illustrating an example of a deadheading control process routine. The deadheading control process is performed by the CPU 11 functioning as the deadheading control unit 136 to execute the following steps.

In step S200, the CPU 11 acquires information on the vehicles to be deadheaded in individual areas, based on the driving states included in the current driving data. For example, the CPU 11 acquires the information on the vehicles in a state of waiting for instructions as vehicles to be deadheaded, and performs the processes in the following steps on each of the vehicles to be deadheaded. The processes overlapping among steps S202, S204, and S206 may be performed using common processing results.

In step S202, the CPU 11 acquires the demand prediction model, the frequency model, and the obstacle occurrence information.

In step S204, the CPU 11 predicts the demand in individual areas in each time period, based on the demand prediction model. In this example, the CPU 11 predicts the demand in a time period including the current time.

In step S206, the CPU 11 sets the region k (k∈ to K: K is a set of regions of deadheading candidates: k=1, 2, 3 . . . , K) of the deadheading candidate, based on the demand in each region of the area from the prediction results of demand in step S204. The initial value is k=1. For example, if the total of the degrees of demand in regions included in the area is equal to or greater than a certain value, the CPU 11 can determine the area as an area for the deadheading destination candidate, and set the region with demand equal to or greater than a certain level in the area as region k as the deadheading destination candidate.

In step S208, for the set region k, the CPU 11 extracts the candidates for roads to the region k based on the road data.

In step S210, the CPU 11 uses the frequency model to calculate the obstacle prediction coefficient for each of the road candidates related to the region k.

In step S212, the CPU 11 uses the obstacle occurrence information to calculate the obstacle influence coefficient for each of the road candidates related to the region k.

In step S214, the CPU 11 uses an existing algorithm to generate a driving route to the region k based on the road candidates, the obstacle prediction coefficient, and the obstacle influence coefficient. The CPU 11 also calculates the movement cost (movement time) related to the driving route.

In step S216, the CPU 11 calculates the deadheading sales prospect in the region k, based on the obstacle prediction coefficient, the obstacle influence coefficient, the movement cost (movement time) related to the driving route, and the sales prospect per vehicle in the region k.

In step S218, the CPU 11 determines whether the calculation of the deadheading sales prospect has completed on all the regions k. The determination is made depending on whether k<K. If the calculation has completed, the process moves to step S222. If the calculation has not yet completed, the CPU 11 increments k as k=k+1 in step S220. Then, the process returns to step 206 and the CPU 11 sets the next region k and repeats the process.

In step S222, the CPU 11 determines a region k′ with the largest deadheading sales prospect among the regions k, as the deadheading destination of the vehicle to be deadheaded. This step may be performed before step S218 to select the region k with the largest deadheading sales prospect in sequence.

In step S224, the CPU 11 transmits the deadheading information to the vehicle 110 to be deadheaded.

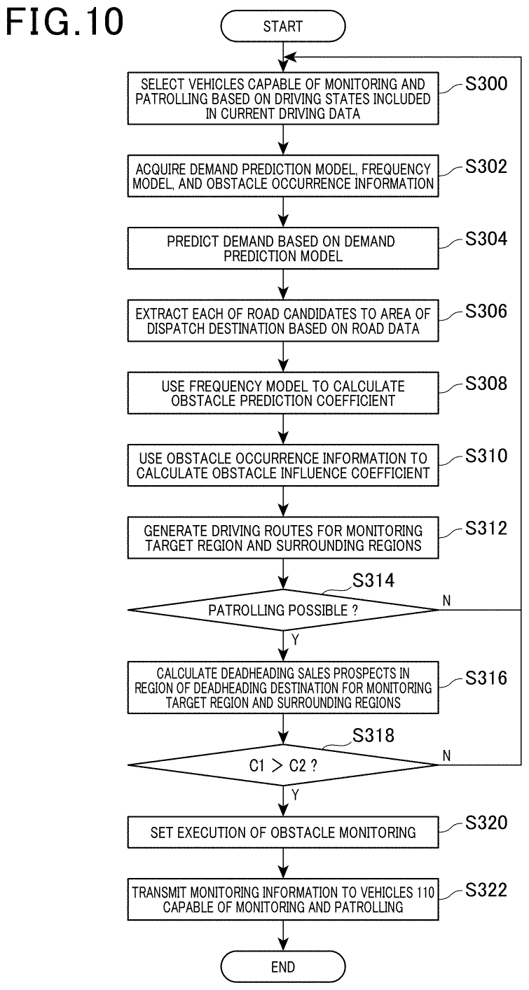

Next, the monitoring control process will be described. FIG. 10 is a diagram illustrating an example of a monitoring control process routine. The monitoring control process is performed by the CPU 11 functioning as the deadheading control unit 136 to execute the following steps. If the occurrence of obstacles in regions of the area is additionally recorded in the obstacle occurrence information, the following steps are executed for each obstacle. The monitoring control process is performed using the data used in the deadheading control process as necessary.

In step S300, the CPU 11 selects vehicles that are located around the area with the obstacle and are capable of monitoring and patrolling, based on the driving states included in the current driving data. For example, the CPU 11 selects the vehicles that are in a state of waiting for instructions and are located within a predetermined range around the region with the obstacle, as vehicles capable of monitoring and patrolling. The following steps are performed on each of the vehicles capable of monitoring and patrolling.

In step S302, the CPU 11 acquires the demand prediction model, the frequency model, and the obstacle occurrence information.

In step S304, the CPU 11 predicts demand in individual areas in each time period. In this example, for each of the vehicles capable of monitoring and patrolling, the CPU 11 predicts demand in the time period including the current time in the surrounding area, on the assumption that the vehicle is deadheaded to the surroundings of the obstacle to be monitored.

In step S306, the CPU 11 extracts each of the candidates of roads to the area of the dispatch destination based on the road data, for each of the vehicles capable of monitoring and patrolling. The extraction targets are the monitoring target region and its surrounding regions.

In step S308, the CPU 11 uses the frequency model to calculate the obstacle prediction coefficient for the road candidates for the vehicle capable of monitoring and patrolling.

In step S310, the CPU 11 uses the obstacle occurrence information to calculate the obstacle influence coefficient for the road candidate for the vehicle capable of monitoring and patrolling.

In step S312, the CPU 11 uses an existing algorithm to generate driving routes to the region to be monitored and its surrounding regions, for the vehicle capable of monitoring and patrolling, based on the road candidates, the obstacle prediction coefficient, and the obstacle influence coefficient.

In step S314, the CPU 11 determines whether it is possible to patrol the monitoring route to the monitoring target, based on the impassable region recorded in the obstacle occurrence information. If it is possible, the process moves to step S316. If it is not possible, the process returns to step S300 and the CPU 11 selects the next vehicle.

In step S316, the CPU 11 calculates the deadheading sales prospect in the deadheading destination, for each of the monitoring target region and its surrounding regions. This process is similar to steps S206 to S222 and thus description thereof will be simplified.

In step S318, the CPU 11 determines whether the deadheading sales prospect (C1) in the monitoring target region exceeds the deadheading sales prospect (C2) to which the cost of dispatching to the surrounding regions is added. If the deadheading sales prospect (C1) exceeds (C2), the process moves to step S320 and the CPU 11 sets the vehicle capable of monitoring and patrolling to monitor the obstacle. If the deadheading sales prospect (C1) does not exceed (C2), the process returns to step S300 without performing the obstacle monitoring, and the CPU 11 selects the next vehicle. The deadheading sales prospect to which the cost of dispatching to the surrounding regions is an example, and the deadheading sales prospect may include only the deadheading sales prospect in the surrounding regions. In the case of adding the cost of dispatching to the surrounding regions, obstacle monitoring is performed only if the monitoring target region has sales prospect greater than that in the surrounding regions.

In step S322, the CPU 11 transmits the monitoring information including the monitoring route to the vehicle 110 capable of monitoring and patrolling.

As described above, according to the drive assistance system in the embodiment of the present disclosure, it is possible to provide drive assistance with consideration given to demand and obstacle status.

The present disclosure is not limited to the embodiment described above but can be modified or increased in application without departing from the gist of the present invention.

In the embodiment described above, as the drive assistance process, the dispatch control process, the deadheading control process, and the monitoring control process are performed. However, the present disclosure is not limited to this configuration. For example, only the deadheading control process may be performed, or only the deadheading control process and the dispatch control process may be performed and the monitoring control process may be performed by a different apparatus.

The embodiment described herein is based on the assumption that programs are pre-installed in the apparatus. Alternatively, the programs may be stored and provided in a computer-readable recording medium.

The drive assistance process executed by the CPU reading software (program) in the embodiment described above may be executed by various processors other than the CPU. In this case, examples of the processors include dedicated electric circuits or the like that have a circuit configuration designed for executing specific processes, such as a programmable logic device (PLD) that can be changed in circuit configuration after the manufacture, such as a field-programmable gate array (FPGA), and an application specific integrated circuit (ASIC). The drive assistance process may be executed by one of the various processors, or a combination of two or more processors of the same type or different types (for example, a plurality of FPGAs, a combination of a CPU and an FPGA, or the like). The hardware configuration of the various processors is more specifically an electric circuit in which circuit elements such as semiconductor elements are combined.

In the embodiment described above, the drive assistance program is stored in advance (pre-installed) in the storage unit. However, the present disclosure is not limited to this configuration. The program may be provided in the form of being stored in a non-transitory tangible storage medium such as CD-ROM, DVD-ROM, or USB memory. The program may be downloaded from an external device via a network.

### CONCLUSION

The present disclosure provides a drive assistance apparatus that provides drive assistance with consideration given to demand and obstacle status, a drive assistance method, and a drive assistance program.

A drive assistance apparatus according to an aspect of the present disclosure includes: a demand prediction unit that predicts demand for a vehicle in each area including a driving route, based on a demand prediction model for predicting the demand in the area; a frequency prediction unit that predicts frequency of occurrence of an obstacle in each of regions obtained by dividing the area, based on a frequency model for predicting the frequency of occurrence of an obstacle in the region; and a driving route generation unit that generates a driving route of the vehicle, based on the predicted demand in the area and the predicted frequency of occurrence of obstacles.

A drive assistance method according to an aspect of the present disclosure causes a computer to execute: predicting demand for a vehicle in each area including a driving route, based on a demand prediction model for predicting the demand in the area; predicting frequency of occurrence of an obstacle in each of regions obtained by dividing the area, based on a frequency model for predicting the frequency of occurrence of an obstacle in the region; and generating a driving route of the vehicle, based on the predicted demand in the area and the predicted frequency of occurrence of an obstacle.

A drive assistance program according to an aspect of the present disclosure causes a computer to execute: predicting demand for a vehicle in each area including a driving route, based on a demand prediction model for predicting the demand in the area; predicting frequency of occurrence of an obstacle in each of regions obtained by dividing the area, based on a frequency model for predicting the frequency of occurrence of an obstacle in the region; and generating a driving route of the vehicle, based on the predicted demand in the area and the predicted frequency of occurrence of an obstacle.

According to the drive assistance apparatus, the drive assistance method, and the drive assistance program in the present disclosure, it is possible to provide drive assistance with consideration given to demand and obstacle status.

What is claimed is:

1. A drive assistance apparatus comprising:
a demand prediction unit that predicts demand for a vehicle in each area including a driving route, based on a demand prediction model for predicting the demand in the area;
a frequency prediction unit that predicts frequency of occurrence of an obstacle in each of the regions obtained by dividing the area, based on a frequency model for predicting the frequency of occurrence of the obstacle in the region; and
a driving route generation unit that generates the driving route of the vehicle as a route to a deadheading destination, by calculating an achievement prospect using a first coefficient that indicates a risk of passableness and impassableness due to the obstacle in accordance with the frequency of occurrence of the obstacle, a second coefficient that indicates influence of the obstacle existing on the driving route, and demand per vehicle in the demand in the area, for each region of a deadheading candidate based on the demand.

2. The drive assistance apparatus according to claim 1, wherein the frequency model is a model that has been learned in advance based on information on an impassable region due to occurrence of the obstacle in the past, predetermined external data, and a road structure of the region.

3. The drive assistance apparatus according to claim 1, further comprising a monitoring control unit that, for a target obstacle exiting on the driving route, predicts a staying time of the target obstacle using a staying prediction model for predicting the staying time of the obstacle, and generates a monitoring route in accordance with a prediction result.

4. The drive assistance apparatus according to claim 3, wherein the staying time is predicted while reflecting the target obstacle as a temporary obstacle or a stationary obstacle in the staying prediction model.

5. The drive assistance apparatus according to claim 1, wherein the driving route generation unit determines a vehicle to be dispatched and generates the driving route of the vehicle, based on a vehicle dispatch request from a user and the predicted frequency of occurrence of an obstacle.

6. A drive assistance method causing a computer to execute:
predicting demand for a vehicle in each area including a driving route, based on a demand prediction model for predicting the demand in the area;
predicting frequency of occurrence of an obstacle in each of regions obtained by dividing the area, based on a frequency model for predicting the frequency of occurrence of the obstacle in the region; and
generating a driving route of the vehicle as a route to a deadheading destination, by calculating an achievement prospect using a first coefficient that indicates a risk of passableness and impassableness due to an obstacle in accordance with the frequency of occurrence of the obstacle, a second coefficient that indicates influence of the obstacle existing on the driving route, and demand per vehicle in the demand in the area, for each region of a deadheading candidate based on the demand.

7. A drive assistance program causing a computer to execute:
predicting demand for a vehicle in each area including a driving route, based on a demand prediction model for predicting the demand in the area;
predicting frequency of occurrence of an obstacle in each of regions obtained by dividing the area, based on a frequency model for predicting the frequency of occurrence of an obstacle in the region; and
generating a driving route of the vehicle as a route to a deadheading destination, by calculating an achievement prospect using a first coefficient that indicates a risk of passableness and impassableness due to the obstacle in accordance with the frequency of occurrence of an obstacle, a second coefficient that indicates influence of the obstacle existing on the driving route, and demand per vehicle in the demand in the area, for each region of a deadheading candidate based on the demand.
